(19) United States
(12) Patent Application Publication
(10) Pub. No.: US 2021/0385883 A1
(43) Pub. Date: Dec. 9, 2021

(54) METHOD AND APPARATUS FOR UNICAST CONNECTION ESTABLISHMENT

(71) Applicant: LENOVO (BEIJING) LIMITED, Beijing (CN)

(72) Inventors: Jing Han, Beijing (CN); Lianhai Wu, Beijing (CN); Xiaodong Yu, Beijing (CN); Zhennian Sun, Beijing (CN); Haiming Wang, Beijing (CN); Jie Hu, Beijing (CN)

(21) Appl. No.: 17/280,438

(22) PCT Filed: Sep. 27, 2018
(86) PCT No.: PCT/CN2018/108067

§ 371 Date: Mar. 26, 2021

(51) Int. Cl. H04W 76/10; H04W 72/04

(52) U.S. Cl. CPC H04W 76/10; H04W 72/04

(57) ABSTRACT

The present disclosure relates to methods and apparatuses for unicast connection setup. According to an embodiment of the present disclosure, a method can include: broadcasting information for unicast connection setup from an initiator user equipment; receiving, from a destination user equipment, a unicast connection setup request in response to the information for unicast connection setup; and transmitting a unicast connection setup message to the destination user equipment in response to the unicast connection setup request. Embodiments of the present disclosure propose a novel unicast connection setup procedure, which can meet the advanced V2X service requirements.

### TECHNICAL FIELD

The present disclosure is related to wireless communication technology, and more particularly, related to unicast connection establishment between UEs (user equipment).

### BACKGROUND

To expand the 3GPP (3rd Generation Partnership Project) platform to the automotive industry, the initial standard on support of V2V (vehicle to vehicle) services was completed in September 2016. Enhancements focusing on additional V2X (vehicle to everything) operation scenarios leveraging the cellular infrastructure, are completed in March 2017 as 3GPP V2X phase 1 for inclusion in Rel-14 LTE (Long Term Evolution).

3GPP V2X phase 2 in Rel-15 LTE introduces a number of new features in sidelink, including: carrier aggregation, high order modulation, latency reduction, and feasibility study on both transmission diversity and short TTI (Transmission Time Interval) on sidelink.

3GPP V2X phase 3 in NR (New radio) identifies 25 use cases for advanced V2X services, which are categorized into four use case groups: vehicles platooning, extended sensors, advanced driving and remote driving. Detailed description of each use case group is provided as below.

Vehicles Platooning enables the vehicles to dynamically form a platoon travelling together. All the vehicles in the platoon obtain information from the leading vehicle to manage this platoon. This information allows the vehicles to drive closer than normal in a coordinated manner, going to the same direction and travelling together.

Extended Sensors enables the exchange of raw or processed data gathered through local sensors or live video images among vehicles, road site units, devices of pedestrian and V2X application servers. Vehicles can increase the perception of their environment beyond of what their own sensors can detect and have a more broad and holistic view of the local situation. High data rate is one of its key characteristics.

Advanced Driving enables semi-automated or full-automated driving. Each vehicle shares its own perception data obtained from its local sensors with vehicles in proximity. That allows vehicles to synchronize and coordinate their trajectories or manoeuvres. Each vehicle shares its driving intention with vehicles in proximity.

Remote Driving enables a remote driver or a V2X application to operate a remote vehicle for those passengers who cannot drive by themselves or remote vehicles located in dangerous environments. For a case that variation is limited and routes are predictable, such as public transportation, driving based on cloud computing can be used. High reliability and low latency are the main requirements of the Remote Driving.

Since the advanced V2X services have more variable and strict QoS (Quality of Service) requirements than the services requirements in Rel-14 and Rel-15 LTE V2X, it is important to study Layer-2 /Layer-3 protocols and procedures to support unicast and groupcast design on sidelink, especially the sidelink handling for unicast and groupcast. Accordingly, the industry desires an improved unicast connection establishment procedure to implement the sidelink adaptation and more advanced QoS mechanisms to meet the advanced V2X service requirements.

### SUMMARY OF THE DISCLOSURE

One object of the present disclosure is to provide a technical solution for unicast connection establishment between V2X UEs, which can meet the strict QoS requirement in the advanced V2X services.

According to an embodiment of the present disclosure, a method includes: broadcasting information for unicast connection establishment from a source user equipment; receiving, from a destination user equipment, a unicast connection establishment request in response to the information for unicast connection establishment; and transmitting a unicast connection establishment message to the destination user equipment in response to the unicast connection establishment request.

In an embodiment of the present disclosure, the information for unicast connection establishment includes at least one of: identity information of at least one application, identity information of the source user equipment, position information of the source user equipment, information of a timer for receiving at least one unicast connection establishment request in response to information for unicast connection establishment, and information of reserved resource for receiving at least one unicast connection establishment request in response to the information for unicast connection establishment.

In another embodiment of the present disclosure, the unicast connection establishment request includes at least one of: identity information of at least one application indicated in the broadcast information, identity information of the source user equipment, identity information of the destination user equipment, and position information of the destination user equipment.

In yet another embodiment of the present disclosure, the unicast connection establishment message includes at least one of: identity information of the source user equipment, identity information of the destination user equipment, radio bearer configuration information, QoS configuration information, and radio parameter configuration information.

According to another embodiment of the present disclosure, a method includes: receiving information for a unicast connection establishment broadcast by a source user equipment; and transmitting, from a destination user equipment, a unicast connection establishment request in response to the information for a unicast connection establishment.

In an embodiment of the present disclosure, the method further includes: receiving, from the source user equipment, a unicast connection establishment message in response to unicast connection establishment request; and transmitting a unicast connection establishment complete message to the source user equipment.

In another embodiment of the present disclosure, the method further includes: starting a timer for receiving the unicast connection establishment message, and retransmitting the unicast connection establishment request in the case not receiving the unicast connection establishment message before the timer expires.

Embodiments of the present disclosure also provide an apparatus, including: at least one non-transitory computer-readable medium having computer executable instructions stored therein; at least one receiver; at least one transmitter; and at least one processor coupled to the at least one non-transitory computer-readable medium, the at least one receiver and the at least one transmitter. The computer executable instructions are programmed to implement a method according to an embodiment of the present disclosure with the at least one receiver, the at least one transmitter and the at least one processor.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered limiting of its scope.

FIG. 1 is a flow chart illustrating a method for one-to-one communication establishment in D2D scenario according to an embodiment of the present disclosure;

FIG. 2 is a flow chart illustrating a method for one-to-many communication establishment in D2D scenario according to an embodiment of the present disclosure;

FIG. 3 is a flow chart illustrating a method for unicast connection establishment between UEs according to an embodiment of the present disclosure;

FIG. 4 is a flow chart illustrating a method for unicast connection establishment between UEs according to another embodiment of the present disclosure;

FIG. 5 illustrates a block diagram of an apparatus for unicast connection establishment between UEs according to an embodiment of the present disclosure;

FIG. 6 illustrates a block diagram of an apparatus for unicast connection establishment between UEs according to another embodiment of the present disclosure; and

FIG. 7 is a flow chart illustrating a method for unicast connection establishment between UEs according to yet another embodiment of the present disclosure.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

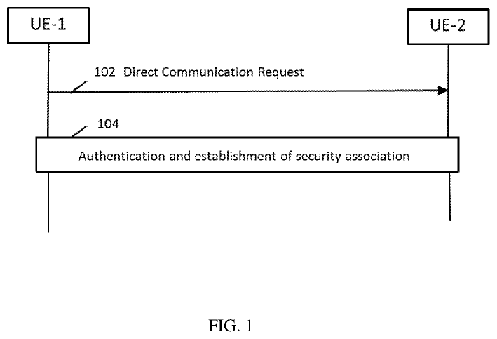

FIG. 1 is a flow chart illustrating a method for one-to-one communication establishment in D2D (Device to Device) scenario according to an embodiment of the present disclosure.

According to an embodiment of the present disclosure, the one-to-one communication is an isolated one-to-one communication between two V2X UEs, for example, UE-1 and UE-2. That is, none of the UEs is a relay node. Both of UE-1 and UE-2 can be a vehicle.

As shown in FIG. 1, in step 102, UE-1 may send a Direct Communication Request message to UE-2 to trigger mutual authentication. The Direct Communication Request message includes the information of UE-1, for example, the isolated one-to-one communication information indicating whether UE-1 can act as a DHCPv4 (Dynamic Host Configuration Protocol version 4) server, IPv6 (Internet Protocol version 6) router, or both. In the case that the UE-1 does not support any of the IP address allocation mechanisms, the Direct Communication Request message may also include a link-local IPv6 address.

In step 104, in response to the Direct Communication Request message, UE-2 may initiate a procedure for mutual authentication, which may include authentication and establishment of security association. Accordingly, a successful authentication procedure can complete the establishment of the secure layer-2 link over PC5, which is an interface as defined in TS 23.303. Similarly, UE-2 may include the information of UE-2 in a message to UE-1, for example, indicating whether UE-2 can act as a DHCPv4 server, IPv6 router, or both. In the case that UE-2 does not support any of the IP address allocation mechanisms and UE-1 included a link-local IPv6 address in step 102, UE-2 can include a non-conflicting link-local IPv6 address in the message to UE-1. In the case that both UE-1 and UE-2 are selected to use link-local IPv6 address, they can disable the duplicate address detection defined in RFC (Request For Comments) 4862.

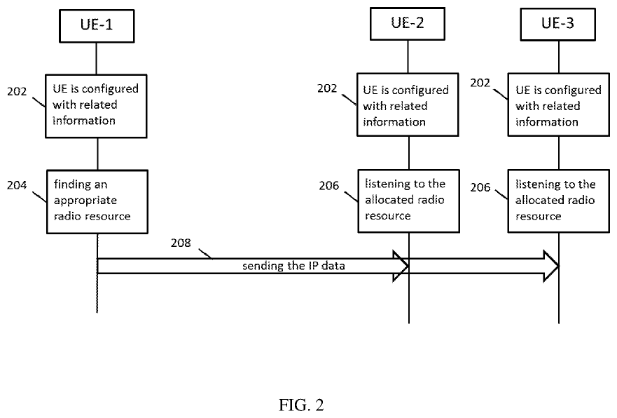

FIG. 2 is a flow chart illustrating a method for one-to-many communication establishment in D2D scenario according to an embodiment of the present disclosure.

As shown in FIG. 2, in step 202, a plurality of UEs, for example UE-1, UE-2, and UE-3 can be configured with related information for one-to-many ProSe (Proximity-based Services) Direct Communication. Each of the plurality of UEs can be a V2X UE, for example a V2X vehicle. In an embodiment of the present disclosure, all of UE-1, UE-2 and UE-3 may be configured with group information. UE-1, UE-2, and UE-3 can obtain necessary group context for transmitting IP-layer transport of data and radio resource related parameters for the Direct Communication based on the group information. The group context may include ProSe Layer-2 Group ID (Identity) and ProSe Group IP multicast address.

In step 204, the source UE, for example UE-1 may find an appropriate radio resource to conduct one-to-many ProSe Direct Communication. Accordingly, in step 206, the destination UEs, for example UE-2 and UE-3 may listen to the allocated radio resource to receive the one-to-many ProSe Direct Communication. Wherein, the protocol data unit passed for transmission to the AS (Access Stratum) among the plurality UEs is associated with: Layer-3 protocol data unit type, corresponding Source Layer-2 ID and Destination Layer-2 ID, and ProSe Per-Packet Priority associated with the protocol data unit. The Layer-3 protocol data types supported for one-to-many ProSe Direct Communication may be IP and Address Resolution Protocol. The Source Layer-2 ID, for example the layer-2 ID of UE-1 can be set to the ProSe UE ID assigned from the ProSe Key Management Function. The Destination Layer-2 ID, for example the layer-2 ID of UE-2 can set to the ProSe Layer-2 Group ID.

In step 208, the source UE, for example UE-1 may send the IP data to the IP multicast address using the ProSe Layer-2 Group ID as the destination Layer-2 ID.

Since PC5 signaling protocol is outside of the Access Stratum (AS) layer, there is only broadcast transmission in physical layer between V2X UEs, but no radio bearer in the AS layer. That is, the above connections under PC5 signaling protocol can only be applied to higher layer (i.e., above the AS layer) logical connections. Accordingly, the AS layer cannot introduce QoS handling and link adaptation mechanism based on the above structure on sidelink, and thus the QoS cannot be guaranteed in the AS layer.

In addition, during the connection establishment procedure in the AS layer, there will be forth and back messages between NR V2X UEs. Due to the half-duplex characteristics of the UEs, in the case that the source UE broadcasts several messages to other UEs, it may miss response messages from destination UEs. For example, the source UE may concurrently transmit V2X information to other V2X UEs at the time or resource that a response message from a destination UE arrives, and thus it cannot receive the response message. That may result in a long delay in connection establishment. However, communication between NR V2X UEs has strict delay requirements. Although blind retransmissions in the physical layer can solve the half-duplex problem, it may result in resource waste and low spectrum efficiency.

Moreover, multiple destination V2X UEs may be interested in unicast connection establishments simultaneously in the AS layer. In the case that the multiple destination UEs are under an automatic resource selection mode, they may select the same resource to transmit the response messages. That may cause a collision among the response message. Since this kind of message is not a periodic message, it is hardly to avoid the collision problem by a legacy sensing mechanism. In the case that the response messages are collided among multiple destination V2X UEs, the AS layer establishment procedure may be interrupted, and has to wait for a long time until the higher layer retransmits the response message.

Therefore, it is necessary to design a novel unicast connection establishment procedure in the AS layer, so that the link adaptation and QoS mechanisms can be implemented in AS layer to meet the advanced V2X service requirements.

Embodiments of the present disclosure propose a novel unicast connection establishment procedure and apparatus, which can meet the advanced V2X service requirements.

More details on the embodiments of the present disclosure will be illustrated in the following text in combination with the appended drawings.

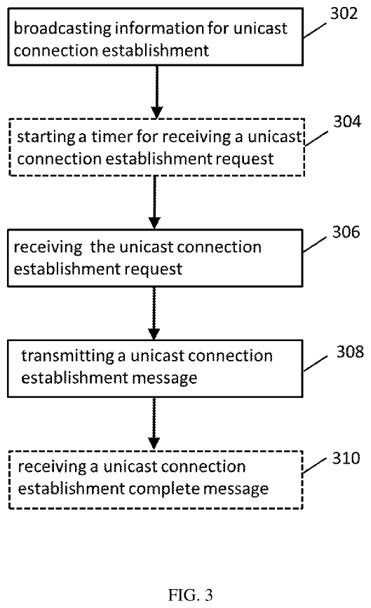

FIG. 3 is a flow chart illustrating a method for unicast connection establishment between UEs according to an embodiment of the present disclosure, which may be performed in a source UE proposing desires for unicast connection establishment, for example, a first UE. The first UE or the source UE may be a computing device, a wearable device, a mobile device, or a vehicle, etc.

As shown in FIG. 3, in step 302, the source UE may broadcast information for unicast connection establishment. This step 302 may be triggered by a higher layer than the AS layer to do unicast transmission on sidelink. The source UE may be a V2X UE. The information for unicast connection establishment may include at least one of: identity information of at least one application, identity information of the first UE, position information of the first UE, information of a timer for receiving at least one unicast connection establishment request in response to information for unicast connection establishment, and information of reserved resource for receiving at least one unicast connection establishment request in response to the information for unicast connection establishment.

The applications may refer to the 25 use cases for advanced V2X services as mentioned above, and the identity information of the at least one application may include at least one of: identity of each application, name of each application, and code passed down from a higher layer of each application. The identity information of the first UE may include a ProSe UE identity, a Layer-2 UE identity, or an identity that passed down from a higher layer. The information of the timer may indicate the value of the timer, and the value of the timer is determined by the first UE.

For example, according to an embodiment of the present disclosure, the first UE may apply a timer-based mechanism for receiving at least one unicast connection establishment request in response to the information for unicast connection establishment. The information for unicast connection establishment may include the following information: identity information of at least one application, identity information of the first UE, position information of the first UE, and information of the timer used by the first UE for receiving at least one unicast connection establishment request in response to the information for unicast connection establishment.

According to another embodiment of the present disclosure, the first UE may apply a timer-based mechanism for receiving at least one unicast connection establishment request, while not indicate the timer information in the broadcast information. Instead, the timer value may be a default value configured by a base station, may be a preconfigured value written into the first UE, or may be a value used in a previous message. The other UEs that can receive the broadcast information for unicast connection establishment may have known the timer. In this embodiment, the information for unicast connection establishment may include: identity information of at least one application, identity information of the first UE, and position information of the first UE.

In another example, the first UE may apply a reserved resource-based mechanism for receiving at least one unicast connection establishment request in response to the broadcast information. The information for unicast connection establishment may include: identity information of at least one application, identity information of the first UE, position information of the first UE, and information of reserved resource for receiving at least one unicast connection establishment request in response to the information for unicast connection establishment. The information of reserved resource may indicate one or more reserved resources for receiving at least one unicast connection establishment request.

According to an embodiment of the present disclosure, the first UE may apply both the timer-based mechanism and the reserved resource-based mechanism for receiving at least one unicast connection establishment request in response to the broadcast information. The information for unicast connection establishment may include: identity information of the first UE, position information of the first UE, information of a timer for receiving at least one unicast connection establishment request in response to information for unicast connection establishment, and information of reserved resource for receiving at least one unicast connection establishment request in response to the information for unicast connection establishment.

Similarly, the first UE may apply both the timer-based mechanism and the reserved resource-based mechanism, while not indicate timer information. In this case, the information for unicast connection establishment may include: identity information of at least one application, and information of reserved resource for receiving at least one unicast connection establishment request in response to the information for unicast connection establishment.

In step 304, in the case that the first UE applies a timer-based mechanism for receiving at least one unicast connection establishment request, the first UE may start a timer upon broadcasting the information for unicast connection establishment. The first UE may keep in a reception mode for receiving at least one unicast connection establishment request in response to the broadcast information before the timer expires. The value of the timer may be the one indicated in the information for unicast connection establishment or may be a default value configured by a base station, may be a preconfigured value written into the first UE, or may be a value used in the previously message in the case that the timer information is not included in the information for unicast connection establishment. Step 304 is optional and can be omitted in other embodiment of the present disclosure, for example, in the case that the first UE only uses the reserved resource-based mechanism for receiving at least one unicast connection establishment request.

In step 306, the first UE may receive a unicast connection establishment request from a destination UE, for example from a second UE before the timer expires. The destination UE is a UE interested in the unicast connection establishment proposed by the first UE or source UE, and may be a V2X UE. Similar to the source UE or first UE, the second UE or the destination UE may be a computing device, a wearable device, a mobile device, or a vehicle, etc. In other embodiment of the present disclosure, the second UE can propose unicast connection establishment in a similar way to the first UE, and act as a source UE. Accordingly, in this case, the first UE can act as a destination UE interested in the unicast connection establishment proposed by the second UE.

In other embodiment of the present disclosure, the first UE may receive the unicast connection establishment request on the reserved resource, or receive the unicast connection establishment request before the timer expires on the reserved resource. For example, in the case that the information of reserved resource indicates one or more reserved resources for receiving at least one unicast connection establishment request, the first UE may receive the unicast connection establishment request on one of the reserved resources.

The unicast connection establishment request may include at least one of: identity information of one or more application of the at least one application indicated in the broadcast information that the second UE, for example a vehicle, identity information of the first UE, identity information of the second UE, and position information of the second UE.

In an embodiment of the present disclosure, the identity information of the second UE may include a ProSe UE identity, a Layer-2 UE identity, or an identity that passed down from a higher layer than the AS layer.

In step 308, the first UE may transmit the unicast connection establishment message to the second UE. The unicast connection establishment message may include at least one of: identity information of the first UE, identity information of the second UE, radio bearer configuration information, QoS configuration information, and radio parameter configuration information.

According to an embodiment of the present application, at least one radio bearer needs to be establishment between the first UE and the second UE, and thus the radio bearer configuration information may include radio bearer configuration information for each radio bearer. The configuration information for each radio bearer may include at least one of: the related QoS flow, radio bearer identity, SDAP (Service Data Adaptation Protocol), PDCP (Packet Data Convergence Protocol), RLC (Radio Link Control), and logical channel configurations related to the radio bearer. The QoS configuration information may include: QoS flow to radio bearer mapping configuration, and logical channel prioritization configuration etc. The radio parameter configuration information may include: physical layer configuration, measurement configuration, and grant free configuration etc.

In optional step 310, the first UE may receive a unicast connection establishment complete message in response to the unicast connection establishment message from the second UE. That means a successful unicast connection between the first UE and second UE has been established.

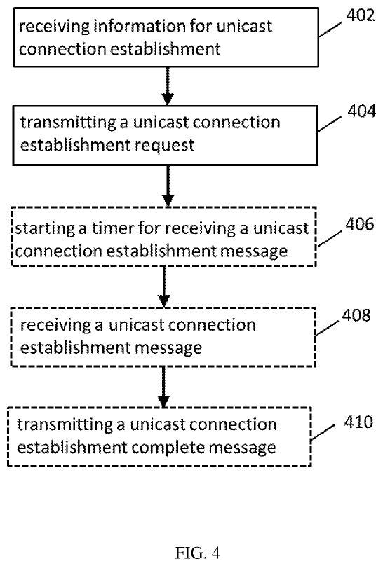

FIG. 4 is a flow chart illustrating a method for unicast connection establishment between UEs according to another embodiment of the present disclosure, which may be performed in the second UE or the destination UE. The second UE or the destination UE may be a V2X UE, which may be a computing device, a wearable device, a mobile device, or a vehicle, etc.

As shown in FIG. 4, in step 402, the second UE may receive the information for unicast connection establishment broadcast by the first UE. The second UE may check the information for unicast connection establishment and determine whether the second UE is interested in establishing a unicast connection with the first UE. For example, the second UE may check the identity information of the at least one application in the information for unicast connection establishment. The second UE may determine whether it is interested in one or more applications based on the identity information of the at least one application. In the case that there are one or more applications that the second UE is interested, it may perform step 404. Otherwise it may keep receiving information for unicast connection establishment, which may from other source UEs or the same source UE.

In step 404, the second UE may transmit a unicast connection establishment request to the first UE. The unicast connection establishment request may include at least one of: identity information of one or more application of the at least one application indicated in the broadcast information that the second UE, for example a vehicle is interested, identity information of the first UE, identity information of the second UE, and position information of the second UE. The identity information of the second UE may include a ProSe UE identity, a Layer-2 UE identity, or an identity that passed down from a higher layer than the AS layer.

According to an embodiment of the present disclosure, the information for unicast connection establishment may include the information of the first timer. The second UE may start a second timer associated with the timer value indicated by the information of the first timer. The second UE may transmit the unicast connection establishment request to the first UE on a resource before the second timer expires. The resource can be randomly selected by the second UE or specifically indicated in the broadcast information by the first UE.

According to another embodiment of the present disclosure, the information for unicast connection establishment may not include the information of the first timer, while a timer-based mechanism for receiving at least one unicast connection establishment request may be configured. The second UE may start a second timer and transmit the unicast connection establishment request to the first UE before the second timer expires. The second timer may have a default value configured by a base station, or a preconfigured value written into the second UE, or a value used in the previously message.

According to yet another embodiment of the present disclosure, the information for unicast connection establishment may include the information of reserved resource. The second UE may transmit the unicast connection establishment request to the first UE on the reserved resource indicated in the broadcast information. In the case that the information of reserved resource indicates multiple reserved resources, the second UE may randomly select one of the multiple reserved resources and transmit the unicast connection establishment request to the first UE on the selected one reserved resource.

In an embodiment of the present disclosure, the information for unicast connection establishment may include both the information of the first timer and the information of reserved resource. The second UE may start a second timer associated the value indicated in the information of the first timer, select one of the reserved resources, and transmit the unicast connection establishment request to the first UE on the selected reserved resource before the second timer expires.

Similarly, the information for unicast connection establishment may include the information of reserved resource and may not include the information of the first timer, while a timer-based mechanism for receiving at least one unicast connection establishment request may be configured. The second UE may start a second timer associated with a default value configured by a base station, or a preconfigured value written into the second UE, or a value used in the previously message, select one of the reserved resources, and transmit the unicast connection establishment request to the first UE on the selected reserved resource before the second timer expires.

In step 406, the second UE may start a third timer for receiving a unicast connection establishment message upon transmitting the unicast connection establishment request to the first UE. In the case that the second UE does not receive the unicast connection establishment message before the third timer expires, the second UE may retransmit the unicast connection establishment request to the first UE. In the case that the second UE receives the unicast connection establishment message before the third timer expires in step 408, the second UE may perform step 410.

Step 406 is also an optional step according to embodiments of the present disclosure. In another embedment, the second UE may retransmit the unicast connection establishment request with blind transmission, which may not need a timer. In some embodiments of the present disclosure, the second UE may not retransmit the unicast connection establishment request even in the case that it does not receive the unicast connection establishment message from the first UE.

In optional step 408, the second UE may receive the unicast connection establishment message from the first UE and apply the parameters in the unicast connection establishment message to establish the radio bearers for the interested application.

According to an embodiment of the present disclosure, in optional step 410, the second UE may transmit a unicast connection establishment complete message to the first UE to indicate a successful unicast connection therebetween has been established.

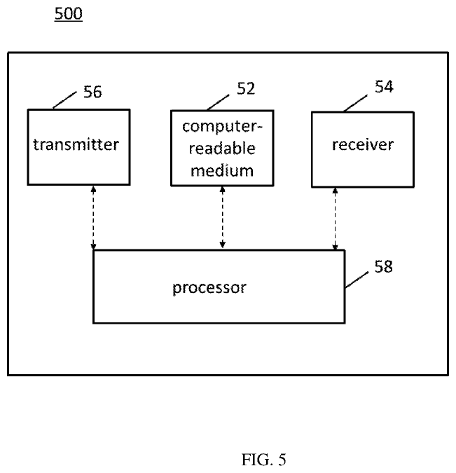

FIG. 5 illustrates a block diagram of an apparatus 500 for unicast connect establishment between V2X UEs according to an embodiment of the present disclosure, wherein the apparatus may be a source UE, for example the first UE.

Referring to FIG. 5, the apparatus 500 may include at least one non-transitory computer-readable medium 52 having computer executable instructions stored therein, at least one receiver 54, at least one transmitter 56; and at least one processor 58 coupled to the at least one non-transitory computer-readable medium 52, the at least one receiver 54 and the at least one transmitter 56. The computer executable instructions can be programmed to implement a method with the at least one receiver 54, the at least one transmitter 56 and the at least one processor 58, the method according to an embodiment of the present disclosure, for example, the method shown in FIG.3.

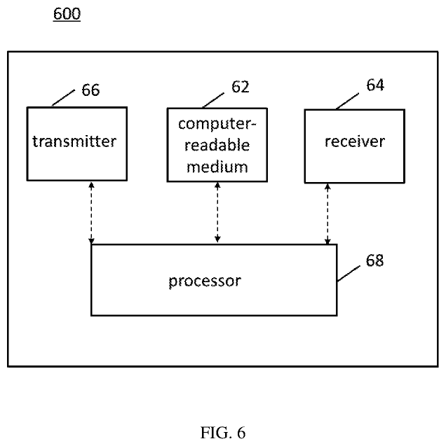

FIG. 6 illustrates a block diagram of an apparatus 600 for unicast connect establishment between V2X UEs according to another embodiment of the present disclosure, wherein the apparatus may be a destination UE, for example the second UE.

Referring to FIG. 6, the apparatus 600 may include at least one non-transitory computer-readable medium 62 having computer executable instructions stored therein, at least one receiver 64, at least one transmitter 66; and at least one processor 68 coupled to the at least one non-transitory computer-readable medium 62, the at least one receiver 64 and the at least one transmitter 66. The computer executable instructions can be programmed to implement a method with the at least one receiver 62, the at least one transmitter 64 and the at least one processor 66, the method according to an embodiment of the present disclosure, for example, the method shown in FIG.4.

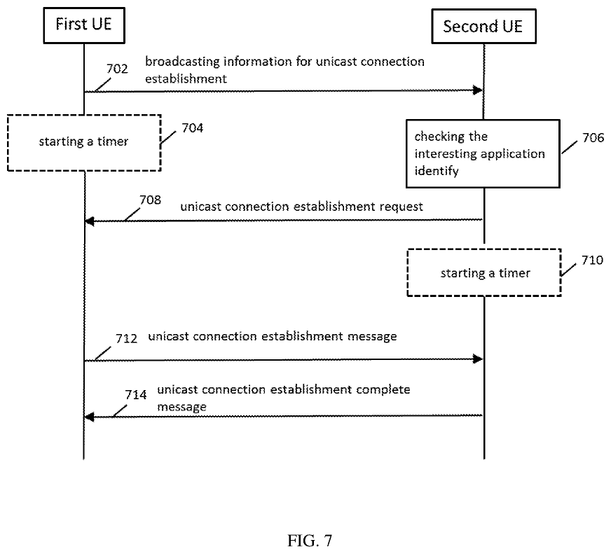

FIG. 7 is a flow chart illustrating a method for unicast connection establishment between V2X UEs according to yet another embodiment of the present disclosure.

As shown in FIG. 7, in step 702, a source UE, for example a first UE may broadcast information for unicast connection establishment. The source UE may be an apparatus shown in FIG.5. The information for unicast connection establishment includes at least one of: identity information of at least one application, identity information of the source UE, position information of the source UE, information of a first timer for receiving at least one unicast connection establishment request in response to information for unicast connection establishment, and information of reserved resource for receiving at least one unicast connection establishment request in response to the information for unicast connection establishment.

According to an embodiment of the present disclosure, the source UE may apply a timer-based mechanism for receiving at least one unicast connection establishment request in response to the information for unicast connection establishment. The information for unicast connection establishment may include: identity information of at least one application, identity information of the source UE, position information of the source UE, and information of the first timer used by the source UE for receiving at least one unicast connection establishment request in response to the information for unicast connection establishment.

The applications may refer to the 25 use cases for advanced V2X services as mentioned above. The identity information of the at least one application includes at least one of: identity of each application, name of each application, and code passed down from a higher layer of each application. The identity information of the source UE includes a ProSe UE identity, a Layer-2 UE identity, or an identity that passed down from a higher layer. The information of the first timer indicates the value of the timer, and the value of the first timer is determined by the source UE.

According to another embodiment of the present disclosure, the source UE may apply a timer-based mechanism for receiving at least one unicast connection establishment request without indicating the timer in the information for unicast connection establishment. The source UE and associated destination UEs may have consensus on the timer, which may be a default value configured by a base station, may be a preconfigured value written into the UE1, or may be a value used in the previously message. In this case, the information for unicast connection establishment may include at least one of: identity information of at least one application, identity information of the source UE, and position information of the source UE.

In an embodiment of the present disclosure, the source UE may apply a reserved resource-based mechanism for receiving at least one unicast connection establishment request in response to the information for unicast connection establishment. In this embodiment, the information for unicast connection establishment may include at least one of: identity information of at least one application, identity information of the source UE, position information of the source UE, and information of reserved resource for receiving at least one unicast connection establishment request in response to the information for unicast connection establishment. The information of reserved resource may indicate one or more reserved resources for receiving at least one unicast connection establishment request.

The source UE may apply both the timer-based mechanism and the reserved resource-based mechanism for receiving at least one unicast connection establishment request in response to the information for unicast connection establishment. In this case, the information for unicast connection establishment may include: identity information of at least one application, identity information of the source UE, position information of the source UE, information of a first timer for receiving at least one unicast connection establishment request in response to information for unicast connection establishment, and information of reserved resource for receiving at least one unicast connection establishment request in response to the information for unicast connection establishment. In the case that the source UE and destination UE have a consensus on the first timer, information on the first timer cannot be included in the broadcast information even in the timer-based mechanism. For example, the first timer may be a default value configured by a base station, may be a preconfigured value written into the UE1, or may be a value used in the previously message.

In step 704, in the case that the source UE applies a timer-based mechanism for receiving at least one unicast connection establishment request, the source UE may start the first timer upon broadcasting the information for unicast connection establishment. Step 704 is optional and may not exist in the case that the first UE only uses the reserved resource-based mechanism for receiving at least one unicast connection establishment request.

In step 706, the destination UE, for example the second UE may receive the information for unicast connection establishment broadcast by the source UE. The destination UE may be an apparatus shown in FIG. 6. The destination UE may check the information for unicast connection establishment to determine whether it is interested in establishing a unicast connection with the source UE. For example, the destination UE may be interested in one or more applications indicated in the information for unicast connection establishment, and may perform step 708. Otherwise, it may keep receiving the information for other unicast connection establishment, which may from other source UEs or the same source UE.

In step 708, the destination UE may transmit a unicast connection establishment request to the source UE. The unicast connection establishment request may include at least one of: identity information of one or more application of the at least one indicated in the broadcast information that destination UE is interested in, identity information of the source UE, identity information of the destination UE, and position information of the destination UE.

In an embodiment of the present disclosure, the identity information of the destination UE may include a ProSe UE identity, a Layer-2 UE identity, or an identity that passed down from a higher layer.

According to an embodiment of the present disclosure, in the case that the information for unicast connection establishment includes the information of the first timer, the destination UE will start a second timer associated with the timer value indicated by the information of the first timer and transmits the unicast connection establishment request to source UE before the second timer expires.

According to another embodiment of the present disclosure, the information for unicast connection establishment may not include the information of the first timer, while the first timer has a default value configured by a base station, or a preconfigured value, or a value used in the previously message. The destination UE may also start a second timer associated with the first timer, and transmit the unicast connection establishment request to the source UE before the second timer expires.

According to yet another embodiment of the present disclosure, the information for unicast connection establishment may include the information of reserved resources, the destination UE may transmit the unicast connection establishment request to the source UE on the indicated reserved resource. In the case that the information of reserved resource indicates multiple reserved resources, the destination UE will randomly select one of the multiple reserved resources and transmit the unicast connection establishment request to the source UE on the selected one reserved resource.

In the case that the information for unicast connection establishment includes both the information of the first timer and the information of reserved resource, the destination UE may start a second timer with the value indicated in information of the first timer and select one of the reserved resources. Then, the destination UE may transmit the unicast connection establishment request to source UE on the selected one reserved resource before the second timer expires.

In step 710, the destination UE may start a third timer for receiving a unicast connection establishment message upon transmitting the unicast connection establishment request to source UE. In the case that the destination UE does not receive the unicast connection establishment message before the third timer expires, the destination UE may retransmit the unicast connection establishment request to the source UE on a randomly select resource. In the case that the destination UE receives the unicast connection establishment message before the third timer expires, destination UE may perform the operation in step 714. Step 710 is optional and the destination UE may not retransmit the unicast connection establishment request. In some embodiments of the present disclosure, the destination UE may perform blind retransmission without the third timer.

In step 712, the source UE may receive the unicast connection establishment message before the first timer expires, on the reserved resource, or on the reserved resource before the first timer expires. The source UE may transmit the unicast connection establishment message to the destination. The unicast connection establishment message may include at least one of: identity information of the first UE, identity information of the destination UE, radio bearer configuration information, QoS configuration information, and radio parameter configuration information.

According to an embodiment of the present application, at least one radio bearer needs to be establishment between the source UE and the destination UE, and thus the radio bearer configuration information may include radio bearer configuration information for each radio bearer. The configuration information for each radio bearer may include the related QoS flow, radio bearer identity, SDAP, PDCP, RLC, logical channel configurations related to the radio bearer. The QoS configuration information may include QoS flow to radio bearer mapping configuration and logical channel prioritization configuration etc. The radio parameter configuration information may include physical layer configuration, measurement configuration, and grant free configuration etc.

In step 714, the destination UE may receive the unicast connection establishment message and may apply the parameters in the unicast connection establishment message to establishment the radio bearers for the application. Then the destination UE may transmit a unicast connection establishment complete message to the source UE to indicate a unicast connection has been successfully established.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for emotion recognition from speech, including a processor and a memory. Computer programmable instructions for implementing a method for emotion recognition from speech are stored in the memory, and the processor is configured to perform the computer programmable instructions to implement the method for emotion recognition from speech. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for emotion recognition from speech as stated above or other method according to an embodiment of the present application.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

1. A method comprising:
broadcasting information for unicast connection establishment from a source user equipment;
receiving, from a destination user equipment, a unicast connection establishment request in response to the information for unicast connection establishment;
and transmitting a unicast connection establishment message to the destination user equipment in response to the unicast connection establishment request.

2. The method of claim 1, comprising receiving, from the destination user equipment, a unicast connection establishment complete message in response to the unicast connection establishment message.

3. The method of claim 1, wherein the information for unicast connection establishment comprises at least one of:
identity information of at least one application;
identity information of the source user equipment;
position information of the source user equipment; information of a timer for receiving at least one unicast connection establishment request in response to information for unicast connection establishment; and
information of reserved resource for receiving at least one unicast connection establishment request in response to the information for unicast connection establishment.

4. The method of claim 1, wherein the unicast connection establishment request comprises at least one of:
identity information of at least one application indicated in the broadcast information;
identity information of the source user equipment;
identity information of the destination user equipment; and
position information of the destination user equipment.

5. The method of claim 1, wherein the unicast connection establishment message comprises at least one of:
identity information of the source user equipment;
identity information of the destination user equipment radio bearer configuration information;
quality of service configuration information; and
radio parameter configuration information.

6. The method of claim 1, comprising:
starting a timer for receiving the unicast connection establishment request; and
keeping in a reception mode for receiving at least one unicast connection establishment request in response to the broadcast information before the timer expires.

7. The method of claim 6, wherein a value of the timer is one of the following:
a value determined by the source user equipment;
a default value configured by a base station; and
a preconfigured value.

8. (canceled)

9. The method of claim 3, wherein the identity information of the source user equipment comprises: a proximity-based services user equipment identity, a layer-2 user equipment identity or an identity that passed down from a higher layer.

10. The method of claim 4, wherein the identity information of the destination user equipment comprises a proximity-based services user equipment identity, a layer-2 user equipment identity, or an identity that passed down from a higher layer.

11. The method of claim 3, wherein the reserved resource for receiving at least one unicast connection establishment request is determined by one of the following:
being determined by the source user equipment;
being configured by a base station; and
being preconfigured.

12. (canceled)

13. A method comprising:
receiving information for a unicast connection establishment broadcast by a source user equipment; and
transmitting, from a destination user equipment, a unicast connection establishment request in response to the information for a unicast connection establishment.

14. The method of claim 13, comprising:
receiving, from the source user equipment, a unicast connection establishment message in response to unicast connection establishment request; and
transmitting a unicast connection establishment complete message to the source user equipment.

15. The method of claim 14, comprising:
starting a timer for receiving the unicast connection establishment message; and
retransmitting the unicast connection establishment request in the case not receiving the unicast connection establishment message before the timer expires.

16. The method of claim 13, wherein the information for the unicast connection establishment comprises at least one of:
identity information of at least one application;
identity information of the source user equipment;
position information of the source user equipment;
information of a timer for receiving at least one unicast connection establishment request in response to information for unicast connection establishment; and
information of reserved resource for receiving at least one unicast connection establishment request in response to the information for unicast connection establishment.

17. The method of claim 13, wherein the unicast connection establishment request comprises at least one of:
identity information of at least one application indicated in the broadcast information;
identity information of the source user equipment;
identity information of the destination user equipment; and
position information of the destination user equipment.

18. The method of claim 14, wherein the unicast connection establishment message comprises at least one of:
identity information of the source user equipment;
identity information of the destination user equipment;
radio bearer configuration information;
QoS quality of service configuration information; and
radio parameter configuration information.

19. The method of claim 13, comprising:
starting a timer after receiving the information for the unicast connection establishment from the source user equipment; and
transmitting the unicast connection establishment request before the timer expires.

20. The method of claim 19, wherein a value of the timer is one of the following:
a value determined by the source user equipment;
a default value configured by a base station; and
a preconfigured value.

21. (canceled)

22. The method of claim 16, wherein the identity information of the source user equipment comprises a proximity-based services user equipment identity, a layer-2 user equipment identity, or an identity that passed down from a higher layer.

23. The method of claim 17, wherein the identity information of the destination user equipment comprises a proximity-based services user equipment identity, a layer-2 user equipment identity, or an identity that passed down from a higher layer.

24. (canceled)

25. (canceled)

26. (canceled)

27. (canceled)
